(19) United States
(12) Patent Application Publication
(10) Pub. No.: US 2003/0196367 A1
(43) Pub. Date: Oct. 23, 2003

(54) Duck in a bucket

(76) Inventor: Charles Douglas Powell, Andersonville, TN (US)

Correspondence Address: Charles Douglas Powell, 205 Big Valley Road, Andersonville, TN, 37705, US

(21) Appl. No.: 10/126,993

(22) Filed: Apr. 22, 2002

(51) Int. Cl. A01M 31/06

(52) U.S. Cl. 43/3

(57) ABSTRACT

A wildfowl decoy apparatus comprising basically of a decoy body with wings spread as if in flight and a motor that causes a support arm to revolve around a floating platform. The decoy body is attached to the outer end of the revolving support arm. The motor attached to the revolving arm causes said arm to turn. As the arm turns said decoy is moved about in a circular pattern as if it is flying. By putting this apparatus on a floating platform, it can be used to attract waterfowl to any desired location. This can be readily converted between motor powered operation and wind powered operation and can be easily dismantled for storage and transportation.

### BACKGROUND

1. Field of invention

The present invention relates generally to animated decoys for attracting wild game. More particularly this invention relates to a waterfowl decoy, which simulates flight.

2. Description of prior art

Decoys have been used for many years to attract wild game. Hunters have realized that stationary, lifeless decoys are not the best way to attract that game. Since live wildfowl do not sit motionless, any movement by decoys adds to the illusion that the decoys are real birds. Therefore the game is more likely to come within the desired range. There are a number of motion creating decoys now in use. Some of these decoys seem to swim. Some resemble a duck feeding to peak the interest of other birds hunting food. Others simply have a vibrating mechanism attached to the bottom or placed inside the body so as to create ripples in the water. Some decoys simulate live wildfowl by including wing movement. This gives the appearance of a bird flapping its wings as if in flight but the decoy remains stationary. This lack of directional movement greatly depreciates the illusion that the decoy is alive. None of the wildfowl decoys available can truly resemble a bird in flight.

### SUMMARY

The present invention relates to a waterfowl decoy apparatus incorporating several structural elements cooperating to provide a very effective attractant for flying waterfowl. The decoy itself is designed and colored such that it resembles waterfowl in flight. Said decoy is then attached to a rotating support arm. Said arm is attached to a motor. When engaged, said motor causes said arm to rotate in a circular pattern. With said decoy attached to revolving end of said arm, when the motor is engaged said decoy will make a circular motion around the apparatus, simulating very effectively a bird in flight. Said motor would be mounted on a floating platform to support the structure above the water level. By mounting the apparatus on a floating platform, the user is no longer limited to shallow water. The apparatus can be easily broken down for transportation and storage. This invention can be readily converted from being powered by an electric motor to being wind powered.

### DESCRIPTION OF DRAWINGS

FIG. 1: An electric motor (1) having a rotating shaft (3) extending vertically out of the top. The motor has electrical connections (2) for a power source.

FIG. 2: A supporting arm (4). Point A of the arm is attached to the rotating shaft (3) so that when the shaft rotates, the outer end of the arm (point B) revolves around the unit. Point B of said arm would extend outward a predetermined distance from the motor.

FIG. 3: Shows a supporting arm (4A) with point A in the center. This arm can be used in place of the arm in FIG. 2 for animating multiple decoys.

FIG. 4: Top view of a decoy which is to be made from a lightweight material and fashioned in the shape of a bird in flight with its wings spread.

FIG. 5: Shows supporting arm (4) securely fastened to shaft (3) on said motor, said decoy (8) is attached to the end of said arm at position B. When said motor is engaged, the support arm turns and the decoy resembles a bird in flight. A counter-weight (5) is shown to give the unit balance when only one decoy is used.

FIG. 6: Shows all pieces together. With motor (1) positioned aboard the floatation device (9), the on board power supply (7) is connected through the power wires (2), and the on/off switch (6). The supporting arm (4) is secured to motor shaft (3). The decoy (8) is then attached directly to supporting arm at point B. When engaged the decoy will move in a circle as if in flight. The counter balance (5) helps keep the unit stable while in motion when only one decoy is used. The unit could sit partially submerged to help stabilize itself as shown by the water level line.

FIG. 7: A top view of a round floating platform (9) with stabilizing wings (10) mounted vertically to the side and extending out from the platform.

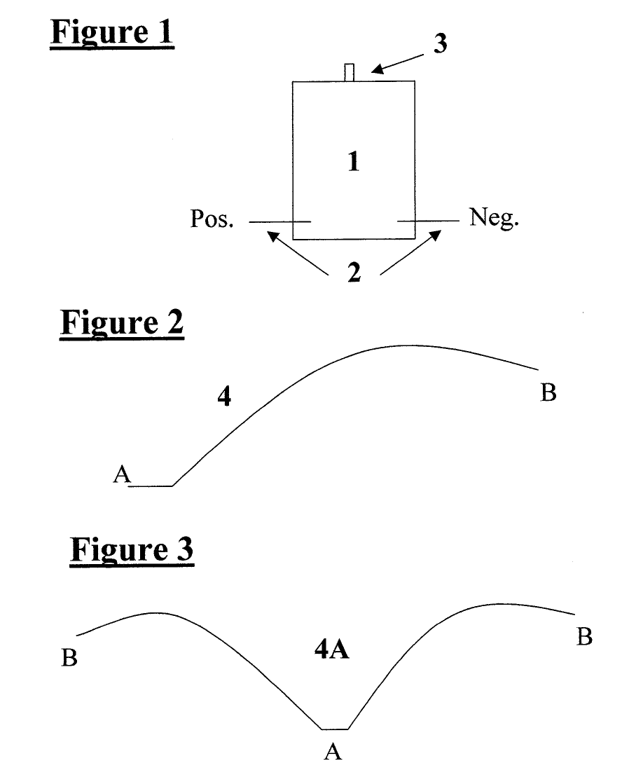

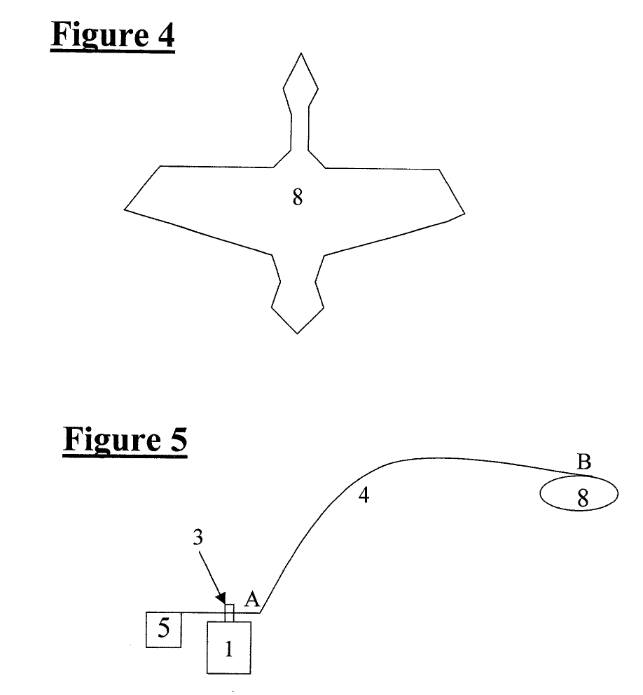

### DESCRIPTION OF PREFERRED EMBODIMENT

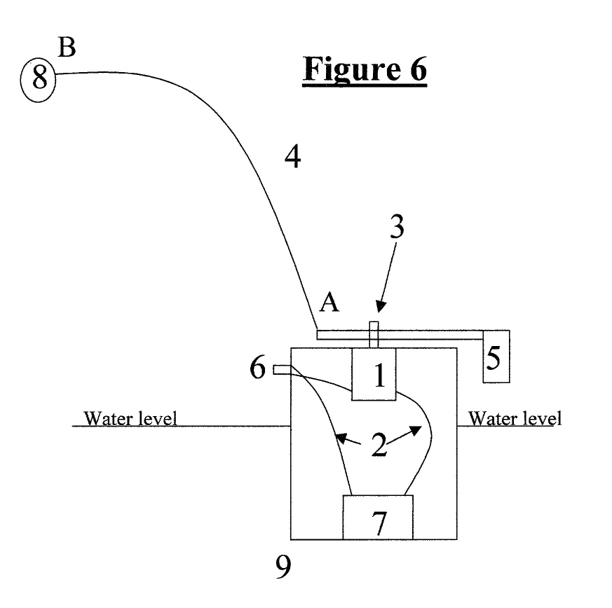

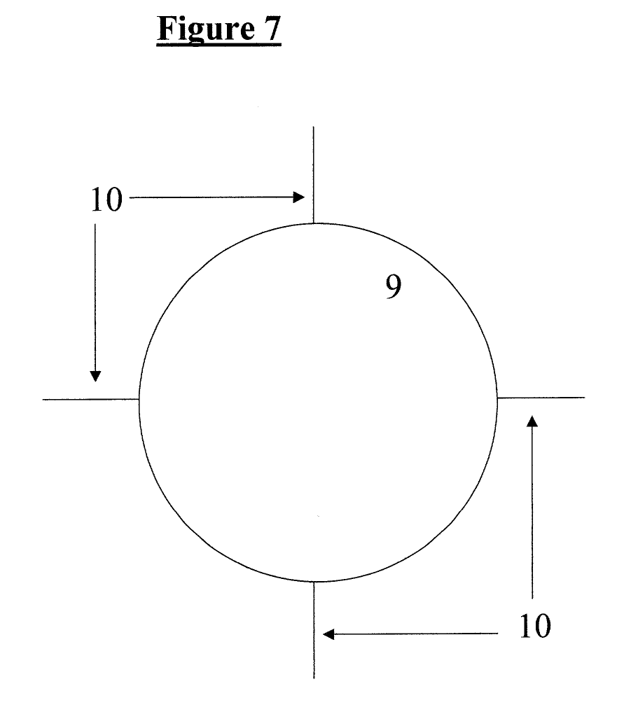

With reference to the drawings, FIG. 6 shows a motor (1) aboard a flotation device. If the flotation device used is round like a bucket, then it could have stabilizing wings (10) attached vertically to the sides so as to restrict the turning motion once it is set in the water. Any type of floating platform could be used to support the structure but a bucket or barrel type platform can also serve as a container for transporting and storage. A power source (7) is mounted in or on the floating platform and electrical connections (2) made to the motor through an on/off switch (6). A remote control mechanism could also be added to control the device from a distance. The flotation device can be weighted to cause it to sit low in the water and be more stable. If only one decoy is used then a counter weight (5) could be used to help stabilize the unit as is shown in FIG. 5. The motor (1) is a gear driven electric motor that turns the shaft (3) an average of 30 RPMs. The shaft extends vertically out of the motor when the motor is mounted atop the flotation device. A support arm (4) such as the one shown in FIG. 2 is securely attached to the shaft (3) and extends out and up from the motor. The support arm is made of a light but rigid material capable of supporting the weight of the decoy to be attached to the outer end. The support arm should also be as small in diameter as possible so as not to draw attention. The decoy is a light-weight, semi-rigid material that is fashioned into the shape of a duck with its wings spread. There are some light-weight decoys already on the market that are designed to sit atop a pole and shake in the wind, these decoys works well. The duck decoy (8) is attached to the outer end of the support arm. When the motor is engaged the motor shaft will spin causing the support arm to rotate and the decoy on the end of the arm will revolve around the floating platform as if flying in a circle. By incorporating the floating platform, the user is not limited to shallow waters like with some other mechanical decoys.

I claim:

1. A decoy assembly for simulating the flight of wildfowl, comprising:
a floating structure supporting a motor;
said motor having a rotating shaft extending from the motor;
at least one supporting arm that attaches to said shaft extending from motor;
at least one decoy being fashioned with wings spread to resemble a bird in flight and attached to revolving end of said support arm;
a power source for supplying power to said motor.

2. The assembly recited in claim 1 wherein said floating structure serves to house the decoy apparatus and keep the decoy above water level.

3. The assembly recited in claim 1 wherein said at least one decoy could comprise a plurality of decoys.

4. The assembly recited in claim 1 wherein said support arm attaches to and extends from said vertical shaft extending from said motor.

5. The assembly recited in claim 1 wherein said power source could be internally mounted as part of the entire device or remotely located.

6. A decoy assembly for simulating the flight of wildfowl, comprising:
a floating structure holding an apparatus designed to harness wind power and to rotate a vertical shaft by that power;
at least one supporting arm that attaches to said vertical shaft;
at least one decoy being fashioned with wings spread to resemble a bird in flight and attached to revolving end of said arm;.

7. The assembly recited in claim 6 wherein said wind-harnessing apparatus is designed such that a slight wind causes said vertical shaft to rotate on its axis.

8. The assembly recited in claim 6 wherein said at least one decoy comprises a plurality of decoys.

9. The assembly recited in claim 6 wherein said supporting arm attaches to said shaft so that when said shaft spins the outer end of said arm revolves around the assembly.
